(19) United States
(12) Patent Application Publication
(10) Pub. No.: US 2024/0370918 A1
(43) Pub. Date: Nov. 7, 2024

(54) ONLINE SYSTEM AND METHOD TO INSTANTANEOUSLY PURCHASE A COMBINED RESIDENTIAL HEATING, VENTILATION AND AIR CONDITIONING (HVAC) SYSTEM AND INSTALLATION SERVICE THEREOF

(71) Applicant: David M Snell, III, Great Falls, VA (US)

(72) Inventor: David M Snell, III, Great Falls, VA (US)

(21) Appl. No.: 18/310,108

(22) Filed: May 1, 2023

(51) Int. Cl. G06Q 30/0601; G06Q 30/0283

(52) U.S. Cl. CPC G06Q 30/0643; G06Q 30/0283; G06Q 30/0627

(57) ABSTRACT

An instantaneous online HVAC system and installation services purchasing system and method thereof. The system enables a residential homeowner to enter information directed to the proper HVAC system for the homeowner's residence to be purchased, and then to receive a plurality of presented options of HVAC systems to select from for purchase together with a predetermined number of installation contractors to choose from to install the selected HVAC. Once the HVAC and installation contractor are selected by the homeowner an all-inclusive price of the selected HVAC system and installation contractor cost will be presented for the homeowner to purchase, without the need for obtaining estimates of installation costs from any installation contractors, thus saving homeowners the time and energy of having to conduct home appointments with each potential installment contractor.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71 (d).

### BACKGROUND OF THE INVENTIVE CONCEPT

### 1. Field of the Inventive Concept

The present inventive concept relates to an instantaneous one stop, one price online all-inclusive system and method to purchase a combined residential heating, ventilation and air conditioning (HVAC) system and installation service thereof. More particularly, but not exclusively, the present inventive concept relates to an instantaneous one stop, one price online all-inclusive system and method to purchase a combined residential heating, ventilation and air conditioning (HVAC) system and installation service simultaneously, which provides the ability for a homeowner (or other purchaser) to instantaneously obtain both a price for a replacement (or new) residential heating, ventilation and air conditioning (HVAC) system together with an all-inclusive installation service cost thereof, and to make a single purchase of the HVAC system and installation service, while eliminating the need for any cost estimate interactions with installation contractors.

### Description of the Related Art

In order to replace a non-functioning HVAC system a homeowner of a residence must shop for a replacement HVAC system which will work for the residence in which the replacement HVAC will be installed. This process of shopping for a replacement HVAC system requires a significant amount of time to review a multitude of different HVAC systems. In addition, the homeowner is also required to contact several different installation contractors, in order to find a contractor that is available or willing to provide the service of installing a replacement HVAC system. Even after the homeowner contacts a plurality of different installation contractors the homeowner is required to schedule a time for each of the potential installation contractors to come to the residence in which a replacement HVAC system is intended to be installed so that each potential installation contractor can review the space in which the replacement HVAC will be installed and then provide the homeowner with an estimate of the costs to perform the installation service. Further, there are often hidden costs which are not made known to the homeowner until the installation services are being performed, leaving the homeowner with additional costs that were not accounted for in making a decision as to which installation contractor to select to perform the service.

U.S. Pat. No. 9,911,147 by Roy discloses a system and method for implementing an automated bidding process in which a preliminary system-generated diagnosis of a heating, ventilation and air conditioning (HVAC) system difficulty can be generated and forwarded to a plurality of available or pre-selected HVAC repair contractors for soliciting and receiving competitive bidding for repair services from those HVAC repair contractors. With this system although a pre-diagnosis may be generated and sent out to a plurality of contractors, the homeowner must receive a plurality of bids from these contractors to review and then schedule a time for the contractors to come to the homeowner's residence to view the HVAC in order to provide an estimate of cost. Further, if considerable parts need to be replaced, or an entire HVAC system needs to be replaced, the homeowner will have to receive estimates from each of the contractors to determine which contractor to choose to repair or replace the HVAC system. The homeowner may still have to order the replacement HVAC system separately from the contractor service costs. As a result of this system and method the homeowner must schedule a time for a plurality of contractors to come to the residence and then provide as estimate of the costs to repair or replace the HVAC system, and then have to determine which replacement HVAC system to purchase and purchase the system separately.

There is a need for a system that enables a homeowner to pay an all-inclusive price to purchase a replacement HVAC system and the required installment services of the replacement HVAC system.

There is also a need for a system that enables a homeowner to order a replacement HVAC system and the required installment services without having to take the time to schedule and conduct contractor visits to the homeowner's residence to obtain estimate costs to replace a HVAC system.

There is also a need for a system that enables a homeowner to order a replacement HVAC system and the required installment services without having to compare estimate costs to replace a HVAC system.

There is also a need for a system that enables a homeowner to select a replacement HVAC system and an installation contractor to install a replacement HVAC system without having to worry about hidden costs for additional parts, permits, warranties, etc.

### SUMMARY OF THE INVENTIVE CONCEPT

The present general inventive concept provides an instantaneous online all-inclusive system and method to purchase a combined residential heating, ventilation and air conditioning (HVAC) system and installation service simultaneously, which provides the ability for a homeowner to instantaneously obtain both a price for a replacement (or new) residential heating, ventilation and air conditioning (HVAC) system together with an all-inclusive installation service cost thereof, and to make a single purchase of the HVAC system and installation service, while eliminating the need for any cost estimate interactions with installation contractors.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system for combining and purchasing a HVAC system and installation service simultaneously, comprising: a server including at least one central processor unit (CPU) having at least one specifically configured search engine and at least one memory unit, the at least one processor unit configured: to generate an interactive homeowner GUI that displays consecutive inquiries for a homeowner to input responses to which determine a type of replacement HVAC needed and to receive the input responses, to search for all HVAC systems and corresponding prices thereof which match the input responses of the homeowner and to present search results of matching HVAC systems to the homeowner through the interactive homeowner GUI for the homeowner to select from, to generate an interactive contractor GUI that enables a contractor to input contractor information including an all-inclusive installation cost to install various different types of HVAC systems, the input contractor information being stored in the at least one memory unit, to search the at least one memory unit for each contractor's input all-inclusive installation costs of respective HVAC systems which match search results of HVAC systems presented to the homeowner and to present a predetermined number of search results of the contractors and corresponding all-inclusive installation costs of HVAC systems to the homeowner to select from, and to receive the homeowner selected a HVAC system and the homeowner selected contractor and corresponding all-inclusive installation cost of HVAC system and to automatically purchase the selected HVAC system and notify the selected contractor of the contractor selection.

In an exemplary embodiment, the displayed consecutive inquiries for a homeowner to input responses can include at least two of: an address of residence for the replacement HVAC to be installed, pictures of existing HVAC system to be replaced, and a model number of the HVAC existing in the residence.

In another exemplary embodiment, the CPU can search each contractor's information to determine if the contractor has a certain level of homeowner approval rating, and if the contractor has a certain level of approval rating, enables the contractor to join a membership to the system by paying a predetermined membership fee and agreeing to a predetermined percentage of the total job cost of installation of the system.

In another exemplary embodiment, the at least one specifically configured search engine can include: a first search engine configured to search for all HVAC systems and corresponding prices which match the input responses of the homeowner; and a second search engine configured to search the at least one memory unit for each contractor's input all-inclusive installation costs of HVAC systems which match search results of HVAC systems presented to the homeowner.

In still another exemplary embodiment, the all-inclusive contractor installation cost can include installation fees, permit fees, warranty fees and all required additional equipment and required materials fees.

In still another exemplary embodiment, the first search engine can be configured to also search property records of the residence to determine the space in which the replacement HVAC will be installed, any additions made to the residence to determine a size of the HVAC system to be installed, and sun exposure of the residence.

The foregoing and/or other features and utilities of the present general inventive concept may also be achieved by providing a method for combining and purchasing a HVAC system and installation service simultaneously, the method comprising: generating, at a central processing unit (CPU) of a server, an interactive homeowner GUI that displays consecutive inquiries for a homeowner to input responses to which determine a type of replacement HVAC needed and receives the input responses at the CPU, searching, at the CPU, all HVAC systems and corresponding prices which match the input responses of the homeowner and presenting search results of matching HVAC systems to the homeowner through the interactive homeowner GUI for the homeowner to select from, generating, at the CPU, an interactive contractor GUI that enables a contractor to input contractor information including an all-inclusive installation cost to install various different types of HVAC systems, the input contractor information being stored in at least one memory unit, searching the at least one memory unit for each contractor's input all-inclusive installation costs of HVAC systems which match search results of HVAC systems presented to the homeowner and presenting a predetermined number of search results of the contractors and corresponding all-inclusive installation costs of HVAC systems to the homeowner through the homeowner GUI to select from, and receiving the homeowner selected HVAC system and the homeowner selected contractor and corresponding all-inclusive installation cost of HVAC system at the CPU and simultaneously purchasing the selected HVAC system and notifying the selected contractor of the contractor selection through the CPU.

In an exemplary embodiment, the displayed consecutive inquiries for a homeowner to input responses can include at least two of: an address of a residence for the replacement HVAC to be installed, pictures of existing HVAC system to be replaced, and a model number of the HVAC existing in the residence.

In another exemplary embodiment, each contractor's information can be searched via a pre-configured search engine to determine if the contractor has a certain level of homeowner approval rating, and if it is determined that the contractor has a certain level of approval rating, enabling the contractor to join a membership by paying a predetermined membership fee and agreeing to pay a predetermined percentage of the all-inclusive contractor total job cost of installation to the system.

In another exemplary embodiment, the all-inclusive contractor installation cost can include installation fees, permit fees, warranty fees and all required additional equipment and required materials fees.

In still another exemplary embodiment, the searching all HVAC systems and corresponding prices which match the input responses of the homeowner can further include searching property records of the residence to determine the space in which the replacement HVAC will be installed, searching for any additions made to the residence to determine a size of the HVAC to be installed, and searching sun exposure of the residence.

The foregoing and/or other features and utilities of the present general inventive concept may also be achieved by providing a non-transitory data storage medium storing instructions that, when executed by a processor, cause the processor to execute steps a method of: generating, at a central processing unit (CPU) of a server, an interactive homeowner GUI that displays consecutive inquiries for a homeowner to input responses to which determine a type of replacement HVAC needed and receives the input responses at the CPU, searching, at the CPU, all HVAC systems and corresponding prices which match the input responses of the homeowner and presenting search results of matching HVAC systems to the homeowner through the interactive homeowner GUI for the homeowner to select from, generating, at the CPU, an interactive contractor GUI that enables a contractor to input contractor information including an all-inclusive installation cost to install various different types of HVAC systems, the input contractor information being stored in at least one memory unit, searching the at least one memory unit for each contractor's input all-inclusive installation costs of HVAC systems which match search results of HVAC systems presented to the homeowner and presenting a predetermined number of search results of the contractors and corresponding all-inclusive installation costs of HVAC systems to the homeowner through the homeowner GUI to select from, and receiving the homeowner selected HVAC system and the homeowner selected contractor and corresponding all-inclusive installation cost of HVAC system at the CPU and simultaneously purchasing the selected HVAC system and notifying the selected contractor of the contractor selection through the CPU.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a system for an instantaneous online all-inclusive purchase of a combined residential heating, ventilation and air conditioning (HVAC) system and installation service, according to an example embodiment of the present inventive concept.

The drawing(s) illustrates an exemplary embodiment of the present inventive concept, and is not to be considered limiting in its scope, as the overall inventive concept may admit to other equally effective embodiments.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the FIGURES. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” indicates a unit to process at least one function or operation, wherein the unit may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to an instantaneous online all-inclusive system and method to purchase a residential heating, ventilation and air conditioning (HVAC) system and installation service simultaneously. The instantaneous online all-inclusive system and method provides the ability for a homeowner to instantaneously obtain both a price for a replacement (or new) residential heating, ventilation and air conditioning (HVAC) system together with an all-inclusive installation service costs of potential contractors thereof, and provides a homeowner the ability to make a single purchase of the HVAC system and installation service thereof, while eliminating any need for any cost estimate interactions between the homeowner and the potential installation contractors. Once the HVAC system and installation contractor are simultaneously selected by the homeowner an all-inclusive price for the selected HVAC system and installation contractor service will be presented to the homeowner for the homeowner to make the purchase, thus eliminating any need for searching different types and sizes of HVAC systems and eliminating any cost estimate interactions between the homeowner and the potential installation contractors.

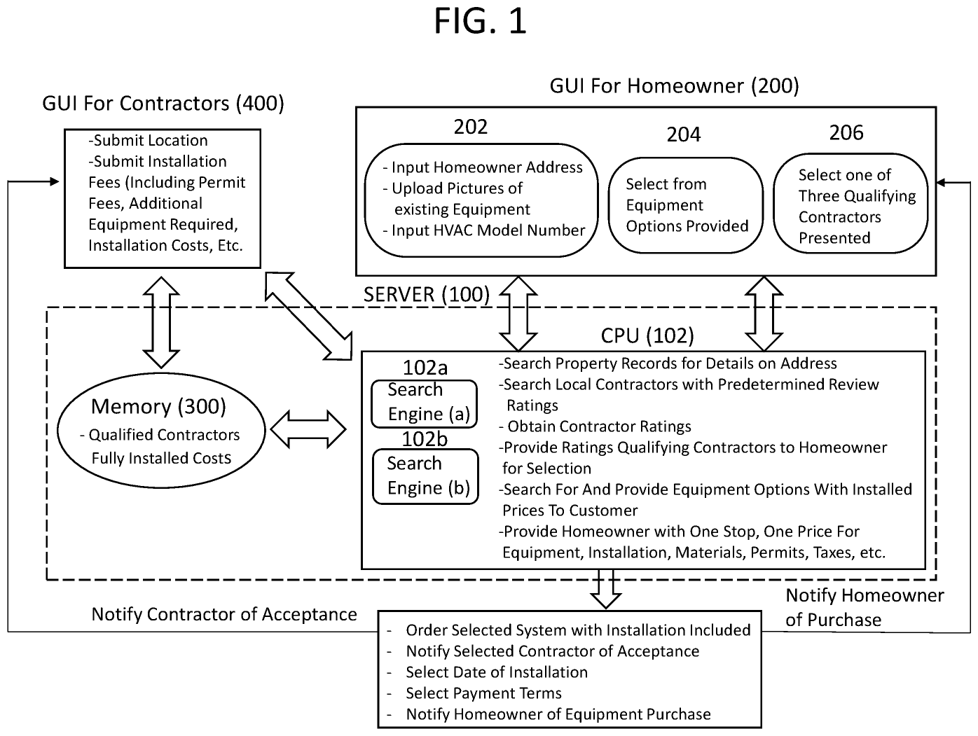

Referring to FIG. 1, a homeowner can call up a website (i.e., MYPRICINGNOW.COM) associated with the online HVAC system and installation services purchasing system server 100 to search for a replacement heating, ventilation and air conditioning (HVAC) system and an installation contractor to install the new HVAC system. The homeowner can simply access the system's server 100 via the server's interactive homeowner GUI 200. Once the homeowner has access to the homeowner GUI 200 the homeowner will have the option to input one or more details relevant to the homeowner's residence and space in which the replacement HVAC system will be installed in an interactive dialog box 202, as well as the existing HVAC (or other heating and air conditioning equipment) model. More specifically, the GUI 200 can present a plurality of consecutive inquiries through the interactive dialog box 202 for the homeowner to input consecutive responses thereto, respectively, regarding the presently installed HVAC and the residence in which the replacement HVAC will be installed.

A computer processing unit (CPU) 102 within the system's server 100 is configured to present to the homeowner, through the interactive dialog box 202, inquiries for the homeowner to answer as input information regarding the residence in which the replacement HVAC is sought to be installed, such as an address of the residence, the square footage of the residence, the age of the residence, any additions made to the residence, the geographical exposure (i.e., southern, western, northern, eastern) of the residence, etc. The computer processing unit (CPU) 102 is also configured to present to the homeowner, through the interactive dialog box 202, inquiries for the homeowner to answer as input information regarding the presently installed HVAC model to be replaced. Additional and/or alternative inquiries can be programmed into the CPU 102 to be presented to the homeowner through the interactive dialog box 202 of the GUI 200 in order to enable the homeowner to input additional information regarding the residence in which the replacement HVAC is sought to be installed, without departing from the spirit and scope of the present inventive concept.

Another feature of the HVAC system and installation services purchasing system server 100 is to enable any HVAC installation contractors to call up the system server's website (i.e., MYPRICINGNOW.COM) and input their all-inclusive costs (all-inclusive) for installation of a plurality of different size and model HVACs. There is no limit to the number of HVAC models and corresponding all-inclusive costs a contractor can input into the server 100. The installation contractors can access a contractor configured GUI 400 presented on the system server's website by the CPU 102 in order to input contractor installation information. More specifically, the installation contractors can input their all-inclusive costs to install all types and models of HVAC systems, including installation costs of each HVAC system itself, costs for any additional parts required to complete the installation, permit costs as required by the state in which the residence is located, and warranty costs for the installation and HVAC system. Accordingly, regardless of the type of HVAC system that a homeowner may need for their specific residence, such as, for example a 40K BTU furnace, or a 100K BTU furnace, the contractors will be required to input the all-inclusive cost of the installation services, the permit cost required to perform the services, any warranty costs that may come with the services, additional parts costs required to complete the installation services, etc. As such, when a homeowner receives options of different contractors to select from, the homeowner will know that the price presented through the interactive homeowner GUI 200 for each contractor to install a replacement HVAC system is an all-inclusive price, thus eliminating any hidden additional costs that would otherwise be presented during installation.

Prior to a HVAC installation contractor inputting their all-inclusive costs for each HVAC system, the contractor can be required to join a membership of the HVAC system and installation services purchasing system 100. Joining the membership by an installation contractor can require a small fee by the server 100, and upon an installation sale that occurs in the contractor's benefit, the HVAC system and installation services purchasing system 100 can require a predetermined percentage commission for the sale. Other alternative forms of payment to the HVAC system and installation services purchasing system 100 can be configured without departing from the spirit and scope of the overall inventive concept.

As pointed out above, the installation contractors can access the HVAC system and installation services purchasing system server 100 via the contractor configured GUI 400, which is presented by the CPU 102 and is accessible via the internet on the system server's website. According to an example embodiment of the present inventive concept, the CPU 102 can also conduct a search of the “ratings” of each installation contractor, via a specifically configured search engine 102a once the installation contractor inputs their information. The CPU 102 can accept or deny each installation contractor's request for membership based on the overall rating of the installation contractor. For example, if an installation contractor has an overall rating of less than 4.6 the CPU 102 can reject the membership request by the contractor. The overall rating level of the contractors required to be accepted into the system's membership can be adjusted as desired.

After an installation contractor has joined the system's membership and has input all-inclusive costs for each type and size (i.e., each different model) of HVAC system in which the contractor performs installation services, these all-inclusive costs can be stored in a memory 300 within the server 100 of the HVAC system and installation services purchasing system according to the present example embodiment illustrated in FIG. 1.

When a homeowner accesses the HVAC system and installation services purchasing system server 100 according to the present example embodiment, the homeowner can access the homeowner GUI 200, where an interactive dialog box 202 presents at least two consecutive inquiries regarding the residence in which a replacement HVAC is intended to be installed, as well as information about the present HVAC model (or type and size) which will be replaced. Once the homeowner has input responses to the interactive dialog box 202 displayed at the GUI 200, a specifically configured search engine 102b of the CPU 102 can perform a plurality of operations in order to search for and obtain all possible replacement HVAC systems that will be compatible with and most efficient for the homeowner's residence. For example, the search engine 102b of the CPU 102 can search the residence's property records for all details on file with the County Records Office. The CPU 102 can then determine the best choice of equipment (i.e., HVAC system and other required materials) through an artificial intelligence (AI) program configured within the search engine 102b. The CPU 102 can also be configured to recommend particular brands of HVAC systems based on efficiency ratings in response to the data input by the homeowner via the dialog box 202 of the GUI 200.

Once the homeowner has responded to all interactive dialog box 202 inquiries the search engine 102b of the CPU 102 can perform the operations of searching for and obtaining all details regarding the residence, searching for all possible compatible and efficient HVAC replacement systems for the particular residence, and obtaining consumer ratings of the compatible and efficient HVAC replacement systems. The CPU 102 can then present a predetermined number of HVAC choices to the homeowner through a dialog box 204 displayed on the homeowner GUI 200.

The search engine 102a of the CPU 102 can search the memory 300 for qualifying installation contractors which have input their all-inclusive costs for all types, sizes and models of HVAC systems in which they can install. The search engine 102a of the CPU 102 can then scan the data of each of these qualifying installation contractors stored within the memory 300 to narrow down the replacement HVAC systems of local contractors which match the data input by the homeowner through the dialog box 202 of the homeowner GUI 200. In other words, the search engine 102a can search through all of the contractors stored in the memory 300 to obtain all-inclusive costs for HVAC systems that correspond with replacement HVAC systems matching the input information entered by the homeowner in dialog box 202. In accordance with an example embodiment, once the search engine 102a has collected all compatible data in the memory 300 the CPU 102 can present to the homeowner three qualifying contractors with their all-inclusive costs to install a replacement HVAC system that matches the HVAC system that is compatible with the homeowner's residence. Alternatively, more or less than three qualifying contractors can be presented depending on the number of prices the homeowner would like to select from. As pointed out above, the HVAC system(s) that are compatible with the homeowner's residence are determined by the input responses by the homeowner through dialog box 202. In accordance with an example embodiment, the CPU 102 can present three choices of installation contractors which qualify under the ratings level requirement, the location of the contractor with respect to the residence of the homeowner, and other requirements that may be added to the CPU 102. These three choices can be presented through an interactive dialog box 206 displayed on the homeowner GUI 200. As a benefit of the specifically configured search engine 102a the CPU 102 can ensure that only all-inclusive installation costs of qualifying contractor information for HVAC systems that match the HVAC system which are compatible with the homeowner's residence are presented in the dialog box 206.

In response to the answers to the inquiries presented by the CPU 102 through the dialog box 202 of the homeowner GUI 200, the homeowner will be instantaneously presented with a plurality of choices of HVAC (or other heating and air conditioning equipment) systems to choose from through the dialog box 204, as well as a predetermined number of choices of installation contractors and their all-inclusive costs to install a corresponding HVAC system through the dialog box 206, such as, for example three choices of installations contractors and their all-inclusive costs to install a corresponding HVAC system can be presented. Alternatively, the CPU 102 can be configured to present any number of choices of installation contractors and their all-inclusive costs to install a corresponding HVAC system through the dialog box 206.

Immediately after the homeowner selects a HVAC system to be installed through the dialog box 204 and an installation contractor to perform the installation of the corresponding HVAC system through the dialog box 206, the CPU 102 of the server 100 will notify the installation contractor that the contractor has been selected. The CPU 102 will also accept the homeowner's payment to purchase the selected HVAC system. Then the CPU 102 can notify the homeowner that the HVAC system has been purchased and that the installation contractor has been notified of the selection. The CPU 102 can also notify the homeowner that the selected installation contractor has accepted the selection. As a result, the entire process of ordering a replacement HVAC system and choosing a contractor to install the replacement HVAC is completed in one step, and the homeowner can be assured that an all-inclusive cost required to install the proper replacement HVAC has been presented. Payment can be completed on the same platform of the CPU 102, where a deposit can placed and then a remainder of the cost can be paid when the HVAC system installment is completed. The installation contractor can receive full payment for installment services by the HVAC system and installation services purchasing system illustrated in FIG. 1 upon completion of the installment services.

In accordance with the HVAC system and installation services purchasing system illustrated in FIG. 1, a homeowner can select the best replacement HVAC system presented by a preferred installment contractor in one step, and the homeowner can also receive an all-inclusive price to cover the cost of a replacement HVAC system and all required costs to complete installation of the replacement HVAC. Moreover, the homeowner can perform this single step of selecting the best replacement HVAC system presented by a preferred installment contractor as well as receiving an all-inclusive price to cover the cost of a replacement HVAC system and all required costs to complete installation of the replacement HVAC without ever having to schedule times to meet with contractors in person at the residence in order for potential contractors to inspect the residence to provide estimates.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for combining and purchasing a HVAC system and installation service simultaneously, comprising:
a server including at least one central processor unit (CPU) having at least one specifically configured search engine and at least one memory unit, the at least one processor unit configured:
to generate an interactive homeowner GUI that displays consecutive inquiries for a homeowner to input responses to which determine a type of replacement HVAC needed and to receive the input responses,
to search for all HVAC systems and corresponding prices thereof which match the input responses of the homeowner and to present search results of matching HVAC systems to the homeowner through the interactive homeowner GUI for the homeowner to select from,
to generate an interactive contractor GUI that enables a contractor to input contractor information including an all-inclusive installation cost to install various different types of HVAC systems, the input contractor information being stored in the at least one memory unit,
to search the at least one memory unit for each contractor's input all-inclusive installation costs of respective HVAC systems which match search results of HVAC systems presented to the homeowner and to present a predetermined number of search results of the contractors and corresponding all-inclusive installation costs of HVAC systems to the homeowner to select from, and
to receive the homeowner selected a HVAC system and the homeowner selected contractor and corresponding all-inclusive installation cost of HVAC system and to automatically purchase the selected HVAC system and notify the selected contractor of the contractor selection.

2. The system according to claim 1, wherein the displayed consecutive inquiries for a homeowner to input responses include at least two of: an address of residence for the replacement HVAC to be installed, pictures of existing HVAC system to be replaced, and an model number of the HVAC existing in the residence.

3. The system according to claim 1, wherein the CPU searches each contractor's information to determine if the contractor has a certain level of homeowner approval rating, and if the contractor has a certain level of approval rating, enables the contractor to join a membership to the system by paying a predetermined membership fee and agreeing to a predetermined percentage of the contractor total job cost of the system.

4. The system according to claim 3, wherein the all-inclusive contractor installation cost includes installation fees, permit fees, warranty fees and all required additional equipment and required materials fees.

5. The system according to claim 1, wherein the at least one specifically configured search engine includes:
a first search engine configured to search for all HVAC systems and corresponding prices which match the input responses of the homeowner; and
a second search engine configured to search the at least one memory unit for each contractor's input all-inclusive installation costs of HVAC systems which match search results of HVAC systems presented to the homeowner.

6. The system according to claim 5, wherein the first search engine is configured to also search property records of the residence to determine the space in which the replacement HVAC will be installed, any additions made to the residence to determine a size of the HVAC to be installed, and sun exposure of the residence.

7. A method for combining and purchasing a HVAC system and installation service simultaneously, the method comprising:
generating, at a central processing unit (CPU) of a server, an interactive homeowner GUI that displays consecutive inquiries for a homeowner to input responses to which determine a type of replacement HVAC needed and receives the input responses at the CPU,
searching, at the CPU, all HVAC systems and corresponding prices which match the input responses of the homeowner and presenting search results of matching HVAC systems to the homeowner through the interactive homeowner GUI for the homeowner to select from,
generating, at the CPU, an interactive contractor GUI that enables a contractor to input contractor information including an all-inclusive installation cost to install various different types of HVAC systems, the input contractor information being stored in at least one memory unit,
searching the at least one memory unit for each contractor's input all-inclusive installation costs of HVAC systems which match search results of HVAC systems presented to the homeowner and presenting a predetermined number of search results of the contractors and corresponding all-inclusive installation costs of HVAC systems to the homeowner through the homeowner GUI to select from, and
receiving the homeowner selected HVAC system and the homeowner selected contractor and corresponding all-inclusive installation cost of HVAC system at the CPU and simultaneously purchasing the selected HVAC system and notifying the selected contractor of the contractor selection through the CPU.

8. The method according to claim 7, wherein the displayed consecutive inquiries for a homeowner to input responses include at least two of: an address of a residence for the replacement HVAC to be installed, pictures of existing HVAC system to be replaced, and a model number of the HVAC existing in the residence.

9. The method according to claim 7, wherein each contractor's information is searched via a pre-configured search engine to determine if the contractor has a certain level of homeowner approval rating, and if it is determined that the contractor has a certain level of approval rating, enabling the contractor to join a membership by paying a predetermined membership fee and agreeing to pay a predetermined percentage of the all-inclusive contractor installation cost.

10. The method according to claim 9, wherein the all-inclusive contractor installation cost includes installation fees, permit fees, warranty fees and all required additional equipment and required materials fees.

11. The method of claim 7, wherein the searching all HVAC systems and corresponding prices which match the input responses of the homeowner further includes searching property records of the residence to determine the space in which the replacement HVAC will be installed, searching for any additions made to the residence to determine a size of the HVAC to be installed, and searching sun exposure of the residence.

12. A non-transitory data storage medium storing instructions that, when executed by a processor, cause the processor to execute steps a method of:
generating, at a central processing unit (CPU) of a server, an interactive homeowner GUI that displays consecutive inquiries for a homeowner to input responses to which determine a type of replacement HVAC needed and receives the input responses at the CPU,
searching, at the CPU, all HVAC systems and corresponding prices which match the input responses of the homeowner and presenting search results of matching HVAC systems to the homeowner through the interactive homeowner GUI for the homeowner to select from,
generating, at the CPU, an interactive contractor GUI that enables a contractor to input contractor information including an all-inclusive installation cost to install various different types of HVAC systems, the input contractor information being stored in at least one memory unit,
searching the at least one memory unit for each contractor's input all-inclusive installation costs of HVAC systems which match search results of HVAC systems presented to the homeowner and presenting a predetermined number of search results of the contractors and corresponding all-inclusive installation costs of HVAC systems to the homeowner through the homeowner GUI to select from, and
receiving the homeowner selected HVAC system and the homeowner selected contractor and corresponding all-inclusive installation cost of HVAC system at the CPU and simultaneously purchasing the selected HVAC system and notifying the selected contractor of the contractor selection through the CPU.
